(19) United States
(12) Patent Application Publication
(10) Pub. No.: US 2026/0319618 A1
(43) Pub. Date: Oct. 15, 2026

(54) SYSTEMS AND METHODS FOR SIMULATING A CAPACITIVE TOUCH INPUT

(71) Applicant: Capital One Services, LLC, McLean, VA (US)

(72) Inventor: Hana WAHI-ANWAR, Frisco, TX (US)

(73) Assignee: Capital One Services, LLC, McLean, VA (US)

(21) Appl. No.: 19/178,327

(22) Filed: Apr. 14, 2025

(51) Int. Cl. G06F 3/041; G06F 3/044

(52) U.S. Cl. CPC G06F 3/0418; G06F 3/044

(57) ABSTRACT

A method may include monitoring, by a first computing device, for a first signal. The method may include receiving, by the first computing device, the first signal via a first connection from a serial port of a second computing device. The method may also include, responsive to receiving the first signal, transmitting, by the first computing device, a second signal to a capacitive sensor via a second connection, the second signal representing a simulated touch input.

### TECHNICAL FIELD

Various embodiments of this disclosure relate generally to techniques for simulating a touch input and, more particularly, to systems and methods for simulating a touch input to test an authentication process in a secure environment.

### BACKGROUND

Many companies develop applications (e.g., software or programs) for the companies' employees or customers to use, and often times the companies wish to secure, or restrict access to, such applications. For example, a company may design an application to be accessible to an employee of the company, on the employee's laptop, only after the employee successfully completes a multi-factor authentication (“MFA”) process using the laptop. A Yubikey® may be plugged into the laptop, and in order for the employee to complete the MFA process and access the application, the employee may need to enter the employee's username and password using the laptop, and then touch a capacitive sensor of the Yubikey®. However, the company may wish to test the MFA process (and the application) multiple times in a secure environment before making the MFA process and the application available to the employee. Yet many existing techniques for testing an MFA process based on a touch input are not secure. Further, where a touch sensor (e.g., of a Yubikey) is coupled to a computer for testing an MFA process, a person is often required to manually touch the touch sensor each time the MFA process is tested, which may be inefficient.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for simulating a touch input to test an authentication process in a secure environment, are disclosed. Each of the examples disclosed herein may include one or more features described in connection with any of the other disclosed examples.

In one aspect, an exemplary embodiment of a method may include monitoring, by a first computing device, for a first signal. The method may include receiving, by the first computing device, the first signal via a first connection from a serial port of a second computing device. The method may also include, responsive to receiving the first signal, transmitting, by the first computing device, a second signal to a capacitive sensor via a second connection, the second signal representing a simulated touch input.

In another aspect, an exemplary embodiment of a computer system may include a processor and a memory having programming instructions stored thereon, which, when executed by the processor, cause the computing system to perform operations. The operations may include monitoring for a first signal. The operations may include receiving the first signal from a serial port of a second computing system. The operations may also include, responsive to receiving the first signal, transmitting a second signal to a capacitive sensor, the second signal representing a simulated touch input.

In a further aspect, an exemplary embodiment of a method may include monitoring, by a first computing device, for a first signal. The method may include receiving, by the first computing device, the first signal from a serial port of a second computing device. The method may also include responsive to receiving the first signal, transmitting, by the first computing device, a second signal to a capacitive sensor, the second signal representing a simulated touch input.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 illustrates an example test system, according to one or more embodiments.

FIG. 3 illustrates an example configuration of a test system, according to one or more embodiments.

FIG. 4 illustrates a flowchart of an example method for providing a simulated touch input, according to one or more embodiments.

FIG. 5 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In the following description, embodiments will be described with reference to the accompanying drawings. As will be discussed in more detail below, various embodiments, systems, and methods for simulating a touch input to test an factor authentication process in a secure environment, are described.

In an exemplary use case, an organization may wish to test an authentication process and an application (e.g., software or a program), on an organization computing system in a secure environment (e.g., a closed-loop system or an environment in which the organization computing system cannot be accessed by unauthorized devices or systems). In some aspects, the authentication process may be configured to secure (or restrict access to) the application. Further, the application may be designed for use (or previously used) by employees of the organization.

The authentication process may be a multi-factor authentication process (e.g., an authentication process involving two or more factors). For example, the authentication process may represent a two-factor authentication process performed using at least the organization computing system. The two-factor authentication process may include, for example, (i) obtaining and verifying, using the organization computing system, a username and password of an employee of the organization (e.g., a first factor or a login process), and (ii) upon verifying the obtained username and password, obtaining and verifying, using the organization computing system, a touch input from the employee (e.g., a second factor). In some embodiments, the organization may use a service account to test the first factor (or the login process).

In some embodiments, to test the second factor of the two-factor authentication process, the organization computing system may be coupled via a first wire to a test system, which may be coupled via a second wire to a Yubikey® (or other authentication system) that is plugged into the organization computing system, thereby forming a closed-loop system. The test system may represent a device that includes the second wire and one or more of (i) a relay or (ii) a servo coupled to a movable arm. In some embodiments, the test system may not be configured to communicate wirelessly (e.g., using WiFi, Bluetooth®, or the like). Further, in some embodiments, the organization computing system and the Yubikey® may not be configured to communicate wirelessly (e.g. at least during testing of an authentication process, as described herein). In some cases, after the first factor of the authentication process is tested using a service account, the second factor may be tested. To begin testing of the second factor, the organization computing system may transmit, via the first wire, a first signal to the testing system (e.g., in response to a previous signal transmitted, via the first wire, from the testing system to the organization computing system). In response to receiving the first signal, the testing system may use the relay (or the servo and the movable arm) to transmit, via the second wire, a second signal to a touch sensor of the Yubikey®. In some embodiments, the second signal may represent a simulated touch input signal or a grounded charge, and the touch sensor may represent a capacitive sensor. Once the Yubikey® receives the second signal, the Yubikey® may send a third signal to the organization computing system. The third signal may represent, for example, that the second signal was received by the Yubikey®, that the second signal was received and verified by the Yubikey®, or that the second signal was received but not verified by the Yubikey®. In some cases, upon receiving the third signal, the organization computing system may verify the second signal. Where the organization computing system or the Yubikey® determines that the second signal is verified, the application may subsequently be tested on the organization computing system using the service account.

Conventional techniques for testing an authentication process based on touch input to a capacitive sensor, often require a person to manually touch the capacitive sensor, which may be inefficient. Further, such techniques may not be conducted in a secure environment. However, aspects of the present disclosure provide systems and methods for testing an authentication process that requires a touch input to a capacitive sensor, in an automated and efficient manner. Further, techniques disclosed herein allow for testing an authentication process using a closed-loop system (e.g., a secure environment). Additionally, aspects of the present disclosure may be integrated with operations for testing applications (or login processes) using service accounts, thereby supporting fully automated, end-to-end testing.

It should be understood that the example above is illustrative only. The techniques and technologies of this disclosure may be adapted to any suitable activity.

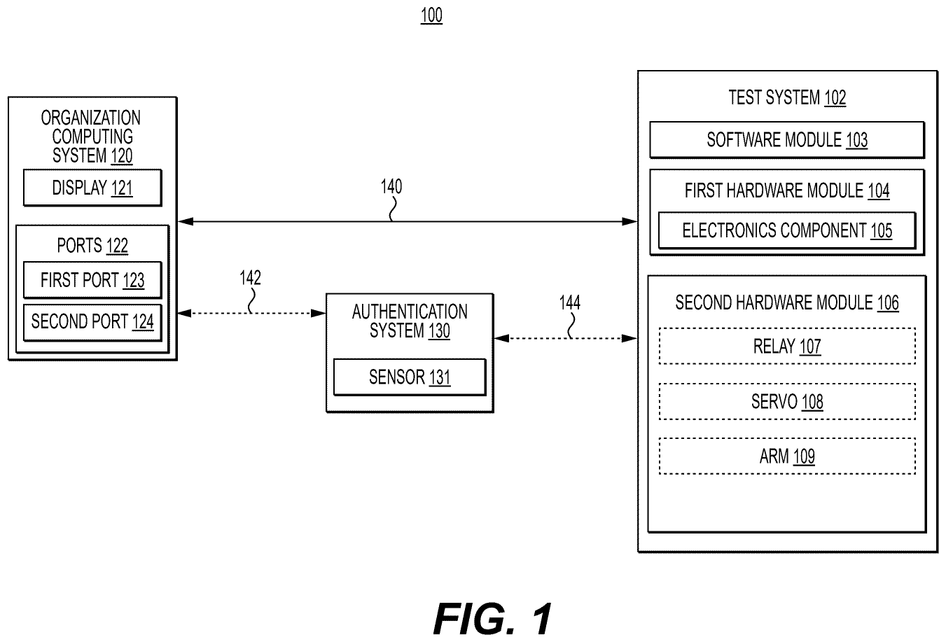

FIG. 1 depicts an example environment 100 that may be utilized with techniques presented herein. As shown in FIG. 1, the example environment 100 may include a test system 102, an organization computing system 120, and an authentication system 130. In some aspects, the test system 102 and the organization computing system 120 may be configured to communicate via a connection 140 (e.g., a wired or wireless connection). The test system 102 and the authentication system 130 may be configured to communicate via a connection 144 (e.g., a wired or wireless connection). The authentication system 130 and the organization computing system 120 may be configured to communicate via a connection 142 (e.g., a wired or wireless connection, or a connection by which the authentication system 130 is directly plugged into the organization computing system 120). In some embodiments, the environment 100 may represent a secure environment. For example, the test system 102, the organization computing system 120, and the authentication system 130 of the environment 100 may be configured to communicate only with one another, via wire or direct coupling, during performance of the methods described herein.

The test system 102 may be a device configured to simulate a touch input (e.g., an input provided by a finger) to the authentication system 130, in order to test an authentication process (e.g., a multi-factor authentication process). In some aspects, the test system 102 may represent an electronic device such as a computer. Further, the test system 102 may be configured to perform methods described in this disclosure. As shown in FIG. 1, the test system 102 may include a software (“S/W”) module 103, a first hardware module 104, and a second hardware module 106. While not shown in FIG. 1, in some embodiments, the first hardware module 104 may include the second hardware module 106.

The software module 103 may include one or more applications configured to be executed on the test system 102. In some embodiments, the test system 102 may be configured to receive the one or more applications of the software module 103. Further, in some embodiments, the one or more applications of the software module 103 may be customizable. In some aspects, the software module 103 may be configured to communicate with the first hardware module 104 and optionally the second hardware module 106. Further, in some aspects, the one or more applications of the software module 103 may be configured to direct, manage, or facilitate the operations of the test system 102 (e.g., of the first hardware module 104 or the second hardware module 106).

The first hardware module 104 may include an electronics component 105. In some aspects, the electronics component 105 may be configured to communicate with the organization computing system 120. More specifically, the electronics component 105 may be configured to communicate with a first port 123 (e.g., a serial port) of the organization computing system 120, via the connection 140. In some embodiments, the connection 140 may represent a wired connection. For example, the connection 140 may include a data synchronization cable configured to connect the electronics component 105 to the first port 123. As another example, the connection 140 may include a data synchronization cable and an adapter cable, each having a respective first end and a respective second end. That is, the first end of the data synchronization cable may be coupled to the electronics component 105, and the second end of the data synchronization cable may be coupled to the first end of the adapter cable. The second end of the adapter cable may be coupled to the first port 123.

In some embodiments, the electronics component 105 may be configured to monitor (e.g., continuously or periodically) for a signal transmitted from the first port 123 to the electronics component 105, via the connection 140. In some aspects, the signal may represent a request for an authenticating touch input, and may be referred to herein as the “request signal.” In some embodiments, the request signal may represent a response to a signal previously transmitted from the electronics component 105 to the first port 123 via the connection 140. Upon receiving (or detecting) the request signal, the electronics component 105 may transmit a signal to the second hardware module 106, where the signal is configured to activate the second hardware module 106. As used herein, such a signal may also be referred to as the “activation signal.” Further, upon receiving (or detecting) the request signal, the electronics component 105 may also transmit a grounded charge to the second hardware module 106. In some aspects, the grounded charge may be a signal representing a simulated touch of a finger, and also be referred to herein as a “simulated touch input signal.” In some embodiments, once the electronics component 105 receives the request signal, the electronics component 105 may transmit the activation signal and the simulated touch input signal to a relay 107 of the second hardware module 106. Further, in some embodiments, once the electronics component 105 receives the request signal, the electronics component 105 may transmit (i) the activation signal to a servo 108 of the second hardware module 106 and (ii) the simulated touch input signal to a wire (e.g., the connection 144) coupled to an arm 109 of the second hardware module 106, where the arm 109 is coupled to the servo 108.

In some aspects, the second hardware module 106 may include one or more of the relay 107, the servo 108, the arm 109, and the connection 144. In some embodiments, the second hardware module 106 may include the relay 107 and the connection 144 (e.g., a wire), but not the servo 108 or the arm 109. In some other embodiments, the second hardware module 106 may include the servo 108, the arm 109, and the connection 144 (e.g., a wire), but not the relay 107.

The relay 107 may represent a switch configured to open and close (e.g., be off or on, respectively). In some embodiments, the relay 107 may include a single channel. Further, the relay may be configured to communicate with a sensor 131 of the authentication system 130 via the connection 144. In some embodiments, the connection 144 may represent a wire (or wired connection), where the wire has a first end coupled to the relay 107, and a second end coupled to (e.g., in direct contact with) the sensor 131. Further, in some embodiments, the relay 107 may be configured to receive an activation signal and a simulated touch input signal from the electronics component 105. In response to (or responsive to) receiving the activation signal, and where the connection 144 represents the wire, the relay 107 may be configured to close, and thereby cause the simulated touch input signal (e.g., the grounded charge) to be transmitted, via the wire, to the sensor 131.

The servo 108 may include a servo motor that is coupled to the arm 109. In some aspects, the arm 109 may have a first end and a second end, where the first end is physically coupled to the servo motor of the servo 108, and the second end is configured to contact (e.g., directly or indirectly) the sensor 131 of the authentication system 130. Where the connection 144 represents a wire, the wire may have a first end coupled to the electronics component 105 and a second end coupled to the second end of the arm 109. In some embodiments, the second end of the arm 109 may be configured to contact, via the wire (or indirectly), the sensor 131. In some other embodiments, each of the second end of the arm 109 and the wire (e.g., the connection 144) may be configured to contact the sensor 131 directly. In some aspects, the servo motor may be configured to move (or control the position of) the arm 109 and the wire. For example, the servo 108 may be configured to receive an activation signal from the electronics component 105, and in response to (or responsive to) receiving the activation signal, the servo motor of the servo 108 may cause the second end of the arm 109 and the second end of the wire to contact the sensor 131. Further, before, during, or after such movement of the arm 109 and the wire, the electronics component 105 may transmit the simulated touch input signal (e.g., the grounded charge) through the wire. When the wire is in contact with the sensor 131 and transmitting the simulated touch input signal, the simulated touch input signal may be delivered to the sensor 131 for a period of time (e.g., a fraction of a second, one or more seconds, or another period of time). In some embodiments, after the simulated touch input signal has been delivered to the sensor 131, the servo motor may cause the arm 109 (and thereby the wire) to move to a different position (e.g., a previous position or a position at which neither the arm 109 nor the wire is in direct contact with the sensor 131).

In some aspects, the organization computing system 120 may be a computer system such as a server, a workstation, a desktop computer, a laptop, a mobile device, a tablet, etc. In some embodiments, the organization computing system 102 may be associated with (e.g., owned, rented, controlled, or used by) an organization such as a company, business, merchant, non-profit, or the like. As shown in FIG. 1, the organization computing system 120 may include a display 121 and ports 122. The display 121 may represent a display screen configured to present, for example, one or more user interfaces for facilitating an authentication process (e.g., a multi-factor authentication process) and one or more applications. In some aspects, each of the authentication process and the one or more applications may be performed (e.g., executed) or tested by the organization computing system 120. For example, during a test of the authentication process, the display 121 may present a user interface the prompts a user to enter a username and password, as a first form of authentication. If the organization computing system 120 receives the username and password, and determines that the username and password are correct, the display 121 may subsequently present a user interface prompts the user to provide a touch input to an authentication system (e.g., the authentication system 130), as a second form of authentication. In some embodiments, where the display 121 presents such a user interface, the organization computing system 120 may (e.g., concurrently) transmit the request signal to the test system 102 via the connection 140. Further, where the organization computing system 120 receives a signal from the authentication system 130 that a received touch input (e.g., a simulated touch input signal) is as expected or is accurate, the testing of the authentication process may conclude. Further, the display 121 may present one or more user interfaces representing an application, to begin testing of the application. Where the organization computing system 120 does not receive a signal form the authentication system 130, or receives a signal from the authentication system 130 that a received touch input (e.g., a simulated touch input signal) is not as expected or is inaccurate, the testing of the authentication process may terminate or start over, for example.

As shown in FIG. 1, the ports 122 may include the first port 123 (e.g., a serial port) and a second port 124 (e.g., a serial port, a Universal Serial Bus port, or another type of port). As described above, the first port 123 may be coupled to electronics component 105, via the connection 140 (e.g., a wire). The first port 123 may also be configured to transmit information to, and receive information from, the electronics component 105, via the connection 140. For example, the first port 123 may be configured to receive a signal from the electronics component 105 via the connection 140, and, for example, in response, to transmit a request signal to the electronics component 105 via the connection 140. The second port 124 may be coupled to the authentication system 130, via the connection 142. In some embodiments, the connection 142 may represent a connection by which the authentication system 130 is directly plugged into the second port 124.

In some aspects, the authentication system 130 may represent a device (e.g., an electronic or computerized device) configured to facilitate an authentication process. As discussed above, the authentication system 130 may include the sensor 131, which may represent a capacitive sensor or touch sensor. In some embodiments, the authentication system 130 may represent a Yubikey®, OnlyKey®, a mobile phone, or another device or system that includes a capacitive sensor or touch sensor. In some aspects, the sensor 131 may be configured to receive a touch input (e.g., from a finger) or a simulated touch input signal (e.g., from the connection 144, where the connection 144 is a wire). In response to (or responsive to) the sensor 131 receiving a touch input or a simulated touch input signal, the authentication system 130 may be configured to transmit a signal to the second port 124 (via the connection 142), where the signal represents the received touch input or received simulated touch input signal.

Although depicted as separate components in FIG. 1, it should be understood that a component or portion of a component in the environment 100 may, in some embodiments, be integrated with or incorporated into one or more other components. For example, the authentication system 130 may be integrated into the organization computing system 120 or the test system 102. In some embodiments, operations or aspects of one or more of the components discussed above may be distributed amongst one or more other components. Any suitable arrangement and/or integration of the various systems and devices of the environment 100 may be used.

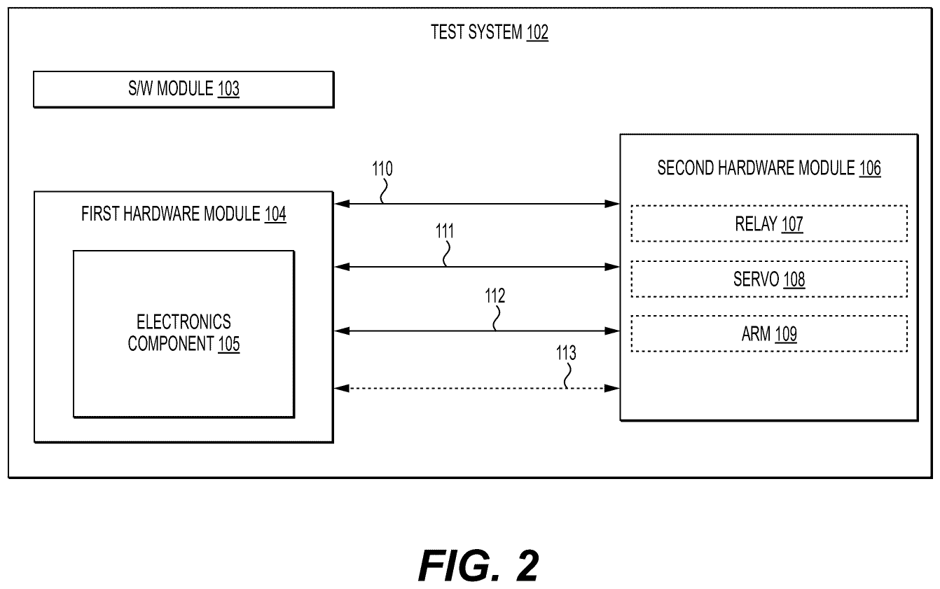

FIG. 2 illustrates an example test system 102, according to one or more embodiments. As shown in FIG. 2, the test system 102 may include the software module 103, the first hardware module 104, and the second hardware module 106. The test system 102 may also include the connection 144 (not shown in FIG. 2). In some aspects, the test system may include one or more of wires 110, 111, 112, or 113 to connect the first hardware module 104 to the second hardware module 106. More specifically, the test system may include one or more of the wires 110, 111, 112, and 113 to facilitate communication (or transmit power) between the first hardware module 104 and the second hardware module 106. For example, the wire 110 may be configured to receive an activation signal from the electronics component 105, and to transmit the activation signal to the relay 107 or the servo 108 of the second hardware module 106. The wire 111 may be configured to transmit power from the first hardware module 104 to the second hardware module 106. The wire 112 may represent a ground wire, or a wire used to establish a common reference voltage for the first hardware module 104 and the second hardware module 106. In some embodiments, the wire 113 may be configured to receive a grounded charge from the electronics component 105, and transmit the grounded charge to the relay 107 (which, when closed, may transmit the grounded charge through a wire representing the wired connection 144, to the sensor 131, for example). Further, in some embodiments, the wire 113 may represent the connection 144, and be coupled to the arm 109. In such embodiments, the wire 113 may be configured to receive a grounded charge from the electronics component 105, and transmit the grounded charge to, for example, the sensor 131. In some aspects, the wire 113 may represent a ground wire.

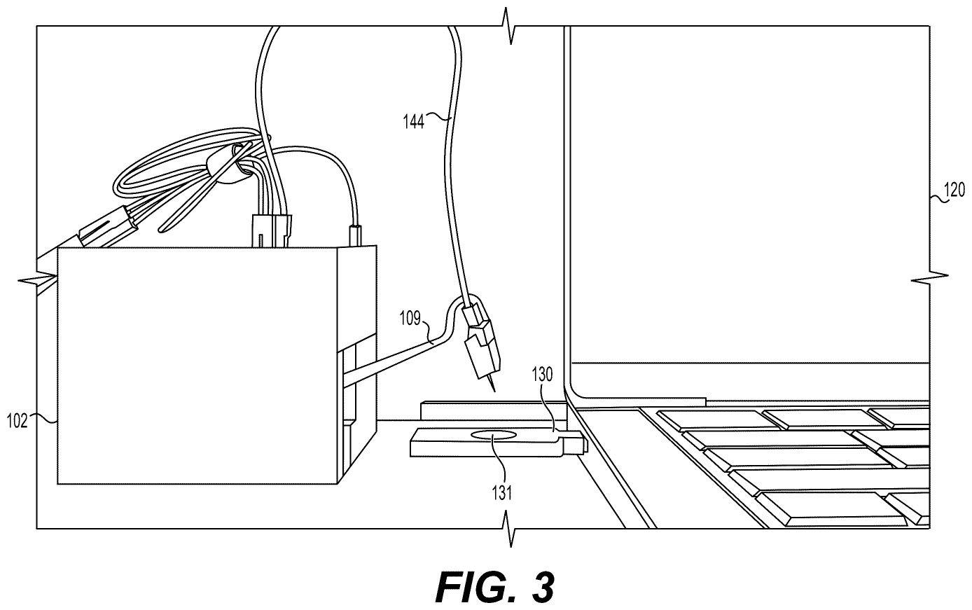

FIG. 3 illustrates an example configuration of the test system 102, according to one or more embodiments. As shown in FIG. 3, the test system 102 may include the arm 109 and a wire representing the connection 144, where the first end of the wire is coupled to the test system 102 and the second end of the wire is coupled to the second end of the arm 109. The test system 102 may also include the servo 108 (not shown in FIG. 3). As shown in FIG. 3, the wire representing the connection 144, and the arm 109, are positioned above (or away from) the authentication system 130, which is plugged into the organization computing system 120. In some embodiments, the servo 108 of the test system 102 may be configured to cause the arm 109 (and in turn, the wire representing the connection 144) to rotate or move toward (or away from) the sensor 131 of the authentication system 130. For example, the servo 108 may cause the arm 109 to rotate (e.g., 10 degrees) or move toward the sensor 131 until the wire representing the connection 144 contacts the sensor 131. The test system 102 may subsequently deliver a simulated touch input signal to the sensor 131 via the wire representing the connection 144.

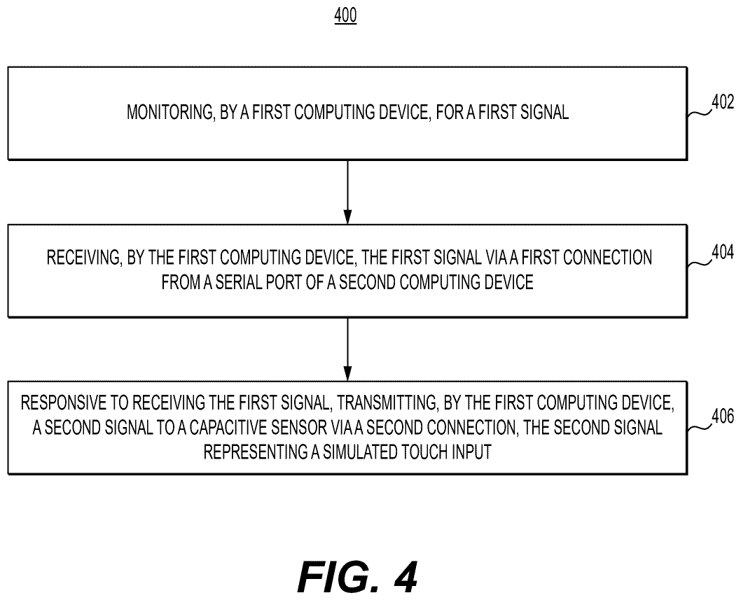

FIG. 4 is a flowchart illustrating a method 400 for providing a simulated touch input, according to one or more embodiments. In some embodiments, the method 400 may represent a method for providing a simulated touch input to test an authentication process in a secure environment. Further, in some embodiments, the method 400 may be performed by the test system 102.

As shown in FIG. 4, the method 400 may include monitoring, by a first computing device (e.g., the test system 102), for a first signal (e.g., a request signal) (402). In some aspects, the first signal may represent a request for an authenticating touch input. In some embodiments, the first computing device may be configured to continuously monitor for the first signal.

The method 400 may include receiving, by the first computing device, the first signal via a first connection (e.g., the connection 140 or a wired connection) from a serial port (e.g., the first port 123) of a second computing device (e.g., the organization computing system 120) (404). The method 400 may also include, responsive to receiving the first signal, transmitting, by the first computing device, a second signal (e.g., a simulated touch input signal) to a capacitive sensor (e.g., the sensor 131) via a second connection (e.g., the connection 144 or a wired connection), the second signal representing a simulated touch input (406). In some embodiments, transmitting, by the first computing device, the second signal to the capacitive sensor via the second connection may include transmitting, via a relay (e.g., the relay 107) of the first computing device, the second signal to the capacitive sensor via the second connection. Further, in some embodiments, the first computing device may include a movable arm (e.g., the arm 109) coupled to the second connection.

In some aspects, the second signal may include a grounded charge. Further, the second signal may represent an input for an authentication process (e.g., an MFA process) being tested. Further, in some embodiments, the capacitive sensor may be included in an authentication device (e.g., the authentication system 130), and may be coupled to the second computing device.

In general, any process or operation discussed in this disclosure that is understood to be computer-implementable, such as the processes or operations described with reference to FIGS. 1-4, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

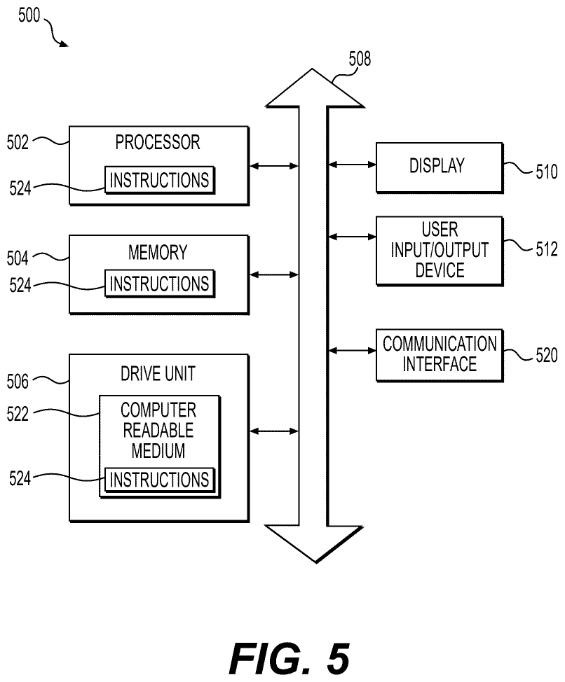

FIG. 5 is a simplified functional block diagram of a computer 500 that may be configured as a device for executing any of the processes, operations, or methods described with references to FIGS. 1-4, according to exemplary embodiments of the present disclosure. For example, the computer 500 may be configured as the testing system 102, the organization computing system 120, or the authentication system 130, according to exemplary embodiments of this disclosure. In various embodiments, any of the devices or systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display (or display screen) 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A method comprising:
monitoring, by a first computing device, for a first signal;
receiving, by the first computing device, the first signal via a first connection from a serial port of a second computing device; and
responsive to receiving the first signal, transmitting, by the first computing device, a second signal to a capacitive sensor via a second connection, the second signal representing a simulated touch input, wherein the capacitive sensor is a component of an authentication device coupled to the second computing device.

2. The method of claim 1, wherein the second signal includes a grounded charge.

3. The method of claim 1, wherein the first signal represents a request for an authenticating touch input.

4. The method of claim 1, wherein the first computing device includes a movable arm coupled to the second connection.

5. (canceled)

6. The method of claim 1, wherein transmitting, by the first computing device, the second signal to the capacitive sensor via the second connection, comprises:
transmitting, via a relay of the first computing device, the second signal to the capacitive sensor via the second connection.

7. The method of claim 1, wherein the second signal represents an input for an authentication process being tested.

8. The method of claim 1, wherein the first computing device is configured to continuously monitor for the first signal.

9. The method of claim 1, wherein each of the first connection and the second connection represents a respective wired connection.

10. (canceled)

11. A first computing system, comprising:
a processor; and
a memory having programming instructions stored thereon, which, when executed by the processor, cause the first computing system to perform operations comprising:
monitoring for a first signal;
receiving the first signal from a serial port of a second computing system; and
responsive to receiving the first signal, transmitting a second signal to a capacitive sensor of an authentication device coupled to the second computing system, the second signal representing a simulated touch input.

12. The first computing system of claim 11, wherein the second signal includes a grounded charge.

13. The first computing system of claim 11, wherein the first signal represents a request for an authenticating touch input.

14. The first computing system of claim 11, wherein the first computing system includes a movable arm coupled to the capacitive sensor via a wired connection.

15. (canceled)

16. The first computing system of claim 11, wherein transmitting the second signal to the capacitive sensor, comprises:
transmitting, via a relay of the first computing system, the second signal to the capacitive sensor.

17. The first computing system of claim 11, wherein the second signal represents an input for an authentication process being tested.

18. (canceled)

19. The first computing system of claim 11, wherein receiving the first signal from the serial port of the second computing system, comprises:
receiving the first signal, via a first wired connection, from the serial port of the second computing system; and wherein transmitting the second signal to the capacitive sensor comprises:
transmitting the second signal, via a second wired connection, to the capacitive sensor.

20. A method of executing an authentication test comprising:
monitoring, by a first computing device, for a first signal;
receiving, by the first computing device, the first signal from a serial port of a second computing device; and
responsive to receiving the first signal, transmitting, by the first computing device, a second signal to a capacitive sensor of an authentication device coupled to the second computing device, the second signal representing a simulated touch input;
wherein the first computing device, the second computing device, and the capacitive sensor are configured to communicate exclusively via wired connections during the authentication test.

21. The method of claim 1, wherein the authentication device is physically separable from the second computing device via a third connection.

22. The method of claim 7, wherein the first computing device, the second computing device, and the capacitive sensor are configured to communicate exclusively via wired connections during the authentication process being tested.

23. The first computing system of claim 11, wherein the authentication device is physically separable from the second computing system.

24. The first computing system of claim 17, wherein the first computing system, the second computing system, and the capacitive sensor are configured to communicate exclusively via wired connections during the authentication process being tested.
